(19) United States
(12) Patent Application Publication
(10) Pub. No.: US 2024/0152306 A1
(43) Pub. Date: May 9, 2024

(54) PARALLAX OCCLUSION RENDERING TO REDUCE MOVEMENT LATENCY

(71) Applicant: GOOGLE LLC, Mountain View, CA (US)

(72) Inventors: Derek James Basehore, Menlo Park, CA (US); Nicholas Jordan Sanders, Saratoga, CA (US)

(21) Appl. No.: 18/281,630

(22) PCT Filed: Mar. 12, 2021
(86) PCT No.: PCT/US2021/022122

§ 371 Date: Sep. 12, 2023

(51) Int. Cl. G06F 3/14; G06T 7/70; G06V 10/74

(52) U.S. Cl. CPC G06F 3/14; G06T 7/70; G06V 10/761

(57) ABSTRACT

A server provides image data including detailed geometry and shading information for one of more objects in a scene from a last known camera orientation and placement (a “first camera view”) and a height map indicating a distance from the first camera view to each pixel of the image. The image data and the height map are collectively referred to as a “parallax pixel map”. A client device receives the parallax pixel map from the server and updates the parallax pixel map based on a current camera orientation and placement (a “first camera view”). The client device projects the updated parallax pixel map onto the image of the scene based on the current camera view to generate a current display frame. The client device then provides the current display frame for display.

### BACKGROUND

Interactive video streaming systems stream video frames from a server to a client device over a network while allowing a user to interact with a virtual environment represented by the streamed video. For example, a game streaming system streams video frames representing a game environment while allowing the user to interact with the game environment via a head mounted display (HMD), game controller, or other input device. The user manipulates the input device to interact with the game environment in a desired manner, and the client device transmits signaling representing the interaction, such as a change in camera perspective, to the server over the network. In response, the server changes a game state corresponding to the game environment and transmits video frames representing the game environment, and based on the new game state, to the client device via the network.

By the time the server has rendered and transmitted a frame to a client device for display, the camera perspective at the client device may have changed, resulting in display of a frame that does not correspond to the current camera perspective. In cases in which the input device is an HMD, poor correspondence or latency between the current camera perspective and the camera perspective of displayed frames can have a large impact on the user experience, even resulting in motion sickness. Even when low latency can be achieved at the server, network performance can cause spikes in latency that result in a poor user experience.

Some game streaming systems attempt to address latency via predictive streaming, wherein the server predicts the expected user input, updates the game state based on the prediction, and streams resulting video frames to the client device before the actual user input is received at the client device, so that the client device can quickly display the resulting video frames in response to the actual user input. However, predictive streaming has limited precision and often falls short on actions such as camera movement, particularly camera movement that is not easily predicted, such as movement that is not exactly forward, backward, left, or right. Movement in virtual reality (VR) games is particularly difficult to predict, as users do not tend to move in exactly straight lines. Even relatively small predictive errors can result in perceptible errors in the streamed video frames, such as the video frames representing a different part of the game environment than is expected by the user.

In addition, the frame rate and responsiveness requirements for VR games are computation intensive, and often result in reduced complexity and detail for graphics. Further, performance issues sometimes result in dropped frames and increased latency, leading to poor user experiences.

It is an object of the present disclosure to provide a method of updating rendered content at a client device based on a current camera view that obviates or mitigates one or more problems associated with known methods, whether identified herein or otherwise.

### SUMMARY

The proposed solution in particular relates to techniques for reducing latency in a game streaming system by modifying rendered content based on a current camera view at a client device prior to displaying the modified content. By modifying the rendered content at the client device, the game streaming system is able to quickly respond to specified inputs, such as a change in the camera perspective. Furthermore, because the modifications are to content that has already been rendered at a server of the game streaming system, the techniques described herein can be implemented with client devices having relatively little rendering or computing power. That is, the game streaming system is able to respond to user inputs at the client device with relatively little latency while still employing the powerful rendering resources of the server, thereby providing an immersive and satisfying game experience for the user.

According to a general aspect, a server renders an image of a scene from a last known camera orientation and placement (referred to as a “first camera view”). The image includes detailed geometry and shading information for one of more objects in the scene. In addition, the server generates a height map indicating a distance from the first camera view to each pixel of the image. The image and the height map are collectively referred to as a “parallax pixel map.” A client device receives the parallax pixel map from the server and updates the parallax pixel map based on the perspective of a current camera orientation and placement (referred to as the “current camera view”). The client device projects the updated parallax pixel map onto the image of the scene based on the current camera view to generate a current display frame. The client device then provides the current display frame for display.

According to a first aspect, there is provided a method comprising a client device receiving a parallax pixel map comprising a first image of a scene comprising a plurality of pixels from a perspective of a first camera view and a height map indicating a distance of each pixel of the image from the first camera view. The method further comprises updating the parallax pixel map based on a perspective of a first current camera view at the client device to generate an updated parallax pixel map comprising at least one of an updated first image and an updated height map, rendering a current display frame based on the updated parallax pixel map, and providing the current display frame for display.

Generating the current display frame may comprise projecting the plurality of pixels of the updated parallax pixel map onto corresponding pixels of the image at a frame buffer.

The method may further comprise identifying a portion of the parallax pixel map based on a portion of the scene that is visible from the first current camera view at the client device and projecting the parallax pixel map may comprise projecting the portion of the parallax pixel map onto the image to generate the current display frame.

Updating the parallax pixel map may comprise updating the height map based on a distance of each pixel of the first image from the first current camera view at the client device.

Updating the parallax pixel map may be based on a change in rotation or position from the first camera view to the first current camera view.

The method may further comprise identifying blank pixels of the first image that have no corresponding pixels of the updated parallax pixel map and assigning values to the blank pixels. The values assigned to the blank pixels may be based on one of values of pixels adjacent to the blank pixels or voxels based on an angle between the first camera view and the first current camera view.

The parallax pixel map may comprise information for rendering pixels that are not visible from the perspective of the first camera view.

The method may further comprise updating the parallax pixel map based on a second current camera view at the client device, generating a second current display frame based on the updated parallax pixel map, and providing the second current display frame for display at the client device.

According to a second aspect, there is provided a method comprising a client device receiving a parallax pixel map comprising an image of a scene from a first camera view comprising a plurality of pixels and a height map indicating a distance of each pixel of the image from the first camera view. The method further comprises identifying a portion of the parallax pixel map that is visible from a current camera view, projecting the portion of the parallax pixel map onto corresponding pixels of the image at a frame buffer to generate a current display frame from a current camera view, and providing the current display frame for display at the client device.

The method may further comprise updating the parallax pixel map based on the current camera view at the client device. Updating may comprise updating the height map based on a distance of each pixel of the image of the scene from the current camera view. Updating may be based on a change in rotation or position from the first camera view to the current camera view.

The method may further comprise identifying blank pixels of the image that have no corresponding pixels of the updated parallax pixel map and assigning values to the blank pixels. The values assigned to the blank pixels may be based on one of values of pixels adjacent to the blank pixels or voxels based on an angle between the first camera view and the current camera view.

The method may further comprise receiving the parallax pixel map from a server having rendered the image based on the first camera view. The parallax pixel map may be part of rendered game content streamed to the client device.

According to a third aspect, there is provided a client device comprising a central processing unit (CPU) to receive a parallax pixel map comprising an image of a scene comprising a plurality of pixels from a first camera view and a height map indicating a distance of each pixel of the image from the first camera view. The client device further comprises a graphics processing unit (GPU) to update the parallax pixel map based on a current camera view, project the updated parallax pixel map onto corresponding pixels of the image to generate a current display frame, and provide the current display frame for display.

The GPU may update the parallax pixel map by updating the height map based on a distance of each pixel of the image of the scene from the current camera view. The GPU may update the parallax pixel map based on a change in rotation or position from the first camera view to the current camera view.

The GPU may identify blank pixels of the image that have no corresponding pixels of the updated parallax pixel map and assign values to the blank pixels. The GPU may assign values to the blank pixels based on one of values of pixels adjacent to the blank pixels or voxels based on an angle between the first camera view and the current camera view.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a game streaming system that updates rendered content at a client device based on a current camera view for display in accordance with some embodiments.

FIG. 2 is a diagram illustrating an example of updated rendered content at the game streaming system of FIG. 1 in accordance with some embodiments.

FIG. 3 is a diagram illustrating an example of a height map received at a client device based on a last known camera view in accordance with some embodiments.

FIG. 4 is a diagram illustrating an example of an updated height map generated at a client device based on a current camera view in accordance with some embodiments.

FIG. 5 is a block diagram illustrating an example of the client device of FIG. 1 projecting an updated parallax map onto a frame buffer in accordance with some embodiments.

FIG. 6 is a diagram illustrating an example of a height map with blank pixels based on a last known camera view in accordance with some embodiments.

FIG. 7 is a diagram illustrating an example of the client device of FIG. 1 assigning values to the blank pixels of FIG. 6 based on a current camera view in accordance with some embodiments.

FIG. 8 is a block diagram illustrating an example of the client device of FIG. 1 assigning values to blank pixels based on a current camera view in accordance with some embodiments.

FIG. 9 is a diagram illustrating an example of rendered content comprising an image of a scene based on a last known camera view received at the client device of FIG. 1 in accordance with some embodiments.

FIG. 10 is a diagram illustrating an example of the client device of FIG. 1 updating the rendered content of FIG. 9 based on a current camera view in accordance with some embodiments.

FIG. 11 is a flow diagram of a method of updating rendered content at a client device based on a current camera view for display in accordance with some embodiments.

### DETAILED DESCRIPTION

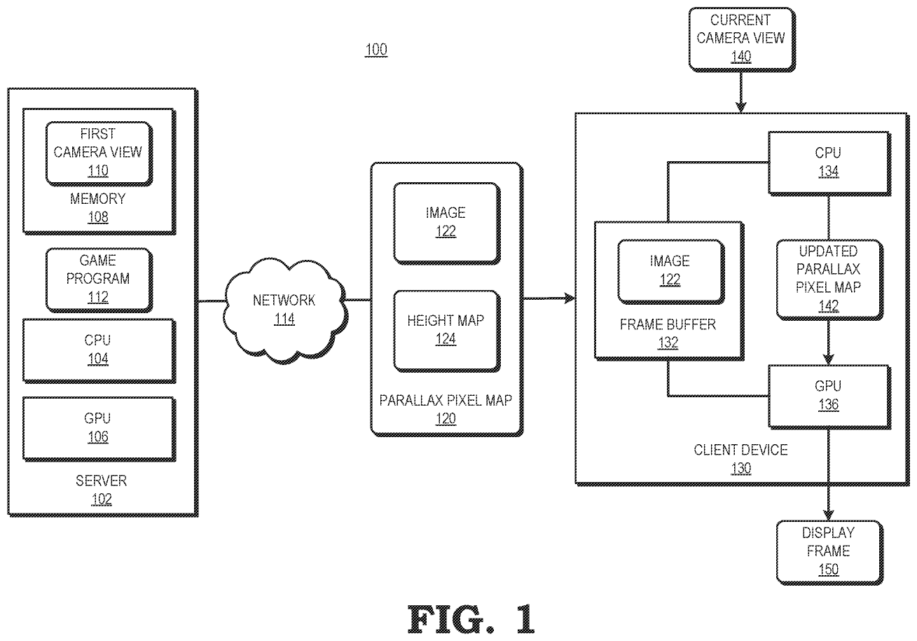

FIGS. 1-11 illustrate techniques for reducing latency in a game streaming system by updating rendered content, such as a portion of a video frame for display, at a client device based on a current camera view prior to displaying the content.

FIG. 1 illustrates a game streaming system 100 that is generally configured to stream rendered game content from a server 102 to a client device 130 and to adjust the rendered game content at the client device 130 based on a current camera view 140. In the depicted example, the server 102 is connected to the client device 130 via a network 114, wherein the network 114 is a packet-switched or other network that is generally configured to communicate data, including video data via one or more routers, servers, communication towers (e.g., cellular communication towers), and the like, or any combination thereof. Accordingly, in various embodiments, the network 114 can be a wide-area network (e.g., the Internet), a local-area network, and the like, or any combination thereof.

The server 102 and the client 130 are generally configured to communicate data via the network 114 in order to collectively implement a streamed game session wherein interactive game content is streamed from the server 102 to the client device 130. Accordingly, the server 102 can be any type of computer device that implements the functionality described further herein, such as a rack-mounted server, a cluster server (i.e., a server device implemented in a cluster of server devices), a mobile server device, and the like, or a combination thereof. The client device 130 can be any computer device that can display video frames to a user and can receive user input, and therefore can be a head mounted display (HMD), desktop or laptop computer, a digital media player, a game console, a smartphone, a tablet, and the like.

To support streaming of game content to the client device during a streamed game session, the server 102 includes a plurality of processing units, such as a central processing unit (CPU) 104, a graphics processing unit (GPU) 106, and a memory 108. The CPU 104 is a processing unit generally configured to execute general purpose sets of instructions, organized in the form of computer programs, to carry out tasks on behalf of the server 102. Examples of such computer programs include operating systems, virtual machines, data security programs (e.g., data encryption/decryption programs), web pages, database programs, and the like.

The GPU 106 is a processing unit generally configured to execute operations associated with graphics and vector processing based on commands received from the CPU 104. For example, in the course of executing one or more general purpose programs, the CPU 104 generates commands to generate and manipulate graphical models for display and provides the commands to the GPU 106. In response, the GPU 106 executes the commands by executing one or more corresponding graphical operations, thereby manipulating the graphical models to generate one or more frames for display. In some embodiments, the frames generated by the GPU 106 are rendered frames comprising detailed geometry and shading information for one or more objects in a scene. As used herein, a rendered frame is a set of pixels that collectively form an image, based on a graphical model, for display at a display device.

The memory 108 includes one or more memory modules to store data on behalf of the CPU 104, the GPU 106, or a combination thereof. Accordingly, the memory 108 can include one or more of random-access memory (RAM) modules, such as dynamic random-access memory (DRAM) modules, non-volatile memory modules, such as flash memory modules or a hard disc drive (HDD), and the like, or any combination thereof.

To support reception and display of streamed game content, the client device 130 includes a CPU 134, a GPU 136, and a frame buffer 132. Each of these modules is analogous to the corresponding module of the server 102. Thus, for example, the CPU 134 is generally configured to execute general-purpose instructions on behalf of the client device 130, such as executing one or more of an operating system, a web browser, and the like. It will be appreciated that, in some embodiments, the CPU 134 and the GPU 136 generally have relatively small compute power relative to the CPU 104 and the GPU 106 of the server 102. The game streaming system 100 thus leverages the computing power of the server 102 to stream game content to the client 130 that is of higher quality than can be generated by the client 130 alone.

In operation, the game streaming system 100 streams game content by executing a game program 112 at the CPU 104. The game program 112 is a set of instructions that collectively implement the rules of the associated game, including rules governing a game environment associated with the game, how user inputs change the game environment, how the game environment is to be displayed, and the like. Execution of the set of instructions results in the CPU 104 maintaining a set of data including a last known camera view, designated first camera view 110, that represents an image of a scene of the game from the perspective of the last known camera orientation and position at the time of rendering a current frame.

Based on the first camera view 110 and the instructions of the game program 112, the CPU 104 sends commands to the GPU 106 to generate and render an image frame from the perspective of the first camera view 110, such as an image frame depicting a game environment, game objects, player and non-player characters, and the like. In some embodiments, the image frame is image data (referred to as image 122) including detailed geometry and shading information for one or more objects in a scene comprising a plurality of pixels from a perspective of the first camera view. For example, in some embodiments, the image 122 includes detailed geometry and shading information for two-dimensional objects in a plurality of layers of varying distance from the first camera view. In addition, the GPU 106 generates a height map 124 indicating a distance of each pixel of the image from the first camera view. The image 122 and the height map 124 are together referred to as a parallax pixel map 120. The GPU 106 provides the parallax pixel map 120 to the client device 130 via the network 114. In some embodiments, the GPU 106 provides the parallax pixel map 120 as metadata to the client device 130. The client device 130 stores the image 122 at a frame buffer 132.

By employing a parallax pixel map that includes an image with detailed geometry and shading for a scene from the last known camera view and a height map indicating the distance of each pixel of the image from the last known camera view, the game streaming system 100 can support adjustments to the displayed frame at the client device 130 based on, for example, a user input indicating a change in the camera orientation and/or position, thereby reducing latency in responses to the user input. For example, the CPU 134 can receive a user input indicating a current camera view 140. In some cases, the current camera view 140 indicates that the camera view has turned, moved, or otherwise changed position in relation to the first camera view 110 in a virtual world associated with the game program 112. In response to the current camera view 140, the CPU 134 generates an updated parallax pixel map 142, reflecting a change in the height map 124 based on the distance of each pixel of the image 122 from the current camera view 140 and/or a change in the amount of the image 122 that is visible from the current camera view 140.

The updated parallax pixel map 142 can indicate a translation, a rotation, a portion (subset) of the parallax pixel map 120, or other adjustment, or any combination thereof. For example, the current camera view 140 can indicate a change in a game character's viewpoint that can be expressed as a three-dimensional translation of +X, +Y, and +Z. The CPU 134 generates the updated parallax pixel map 142 to reflect this three-dimensional translation. In other cases, the current camera view 140 can indicate a three-dimensional rotational change in the game character's viewpoint, expressed as a rotational translation of +P, +Q, +R degrees, and the CPU 134 generates the updated parallax pixel map 142 to reflect this rotational change.

Based on the updated parallax pixel map 142, the GPU 136 changes the aspect (i.e., the position and angle of the viewpoint) of the image 122 that is displayed. For example, if the current camera view 140 is a translation of +X, +Y, and +Z from the first camera view 110, the GPU 136 projects the translation onto a two-dimensional frame of reference associated with the stored image 122 using conventional projection techniques to render a display frame 150. The client device 130 provides the display frame 150 to a display device (not shown), such as a display panel or screen, for display to the user.

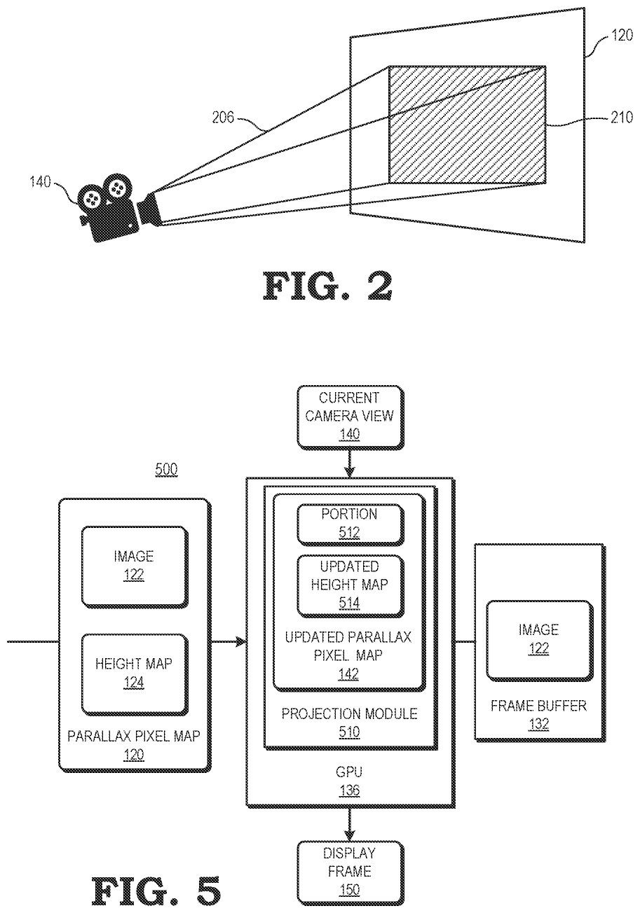

In some embodiments, the client device 130 identifies a portion of the parallax pixel map 120 to use for the updated parallax pixel map 142 by selecting a subset of pixels of the image 122 that are visible from the perspective of the current camera view 140. An example is illustrated at FIG. 2 in accordance with some embodiments. In the depicted example, the GPU 136 casts a ray 206 for four corners of the current camera view 140 onto the parallax pixel map 120 to identify a portion 210 of the image 122 of the parallax pixel map 120 that is visible from the perspective of the current camera view 140. The GPU 136 projects each pixel of the portion 210 of the parallax pixel map onto the image 122 stored at the frame buffer 132 based on the area of the pixel and the distance of each pixel from the current camera view 140.

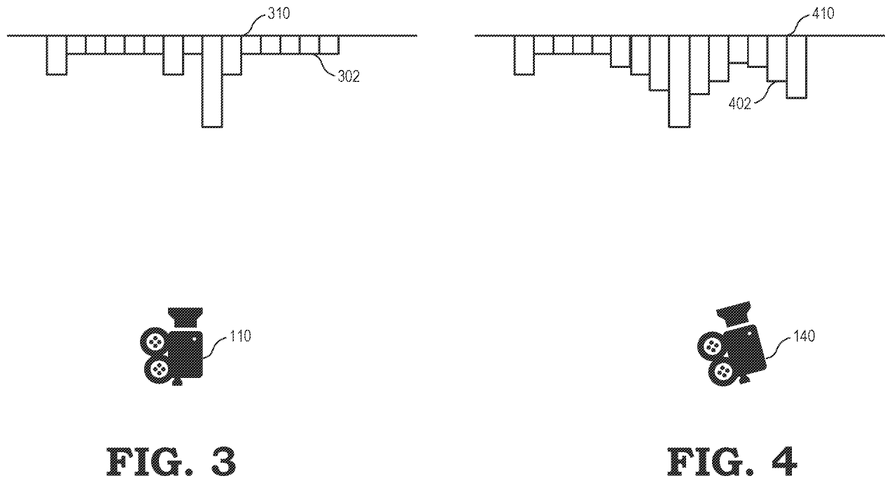

Based on the change in camera orientation and position from a first time when the server GPU 106 rendered the image 122 and generated the height map 124 of the parallax pixel map 120 based on the first camera view 110 and a second time when the client device 130 receives the parallax pixel map 120, the distance of each pixel from the camera view changes. FIG. 3 illustrates an example of a height map 310 received at the client device 130 based on a last known camera view (referred to as a “first camera view”) 110 in accordance with some embodiments. In some embodiments, the height map 310 includes a plurality of pixels such as pixel 302 and an indication for each pixel of the distance of the pixel from the first camera view 110, illustrated in FIG. 3 as the height of each pixel. In other embodiments, the height map 310 includes distance parameter values associated with pixels of the image 122. A change in the orientation and position from the first camera view 110 to a current camera view results in a corresponding change in the distance from each pixel to the current camera view, as illustrated in FIG. 4. FIG. 4 illustrates an example of an updated height map 410 generated at the client device 130 based on the current camera view in accordance with some embodiments. The updated height map 410 includes a plurality of pixels 402 corresponding to the pixels 302 of the height map 310. However, the heights of the pixels are adjusted to indicate an updated distance from each pixel to the current camera view 140.

FIG. 5 is a block diagram illustrating an example 500 of the client device 130 of FIG. 1 projecting an updated parallax pixel map 142 onto the image 122 in accordance with some embodiments. The GPU 136 includes a projection module 510 that is configured to project the updated parallax map 142 onto the image 122 stored at the frame buffer 132 to generate the current display frame 150. The client device 130 receives the parallax pixel map 120 including the image 122 and the height map 124 from the perspective of the first camera view 110 and stores the image 122 at the frame buffer 132. The GPU 136 updates the parallax pixel map 120 based on the current camera view 140 to generate the updated parallax pixel map 142. For example, if the rays for the four corners of the current camera view 140 indicate that the area viewable from the current camera view 140 is smaller than the area of the image 122, the updated parallax pixel map 142 includes only the portion 512 of the parallax pixel map 120 that is visible from the current camera view 140. Further, if the distance of any pixels of the image 122 to the first camera view 110 as indicated in the height map 124 differ from the distance of any of the pixels of the image 122 to the current camera view 140, the GPU 136 updates the height map 124 to indicate the distance of each pixel of the image 122 to the current camera view 140 to generate an updated height map 514. The updated parallax pixel map 142 includes the portion 512 and the updated height map 514. The projection module 510 projects the updated parallax pixel map 142 onto the image 122 at the frame buffer 132 to generate the display frame 150.

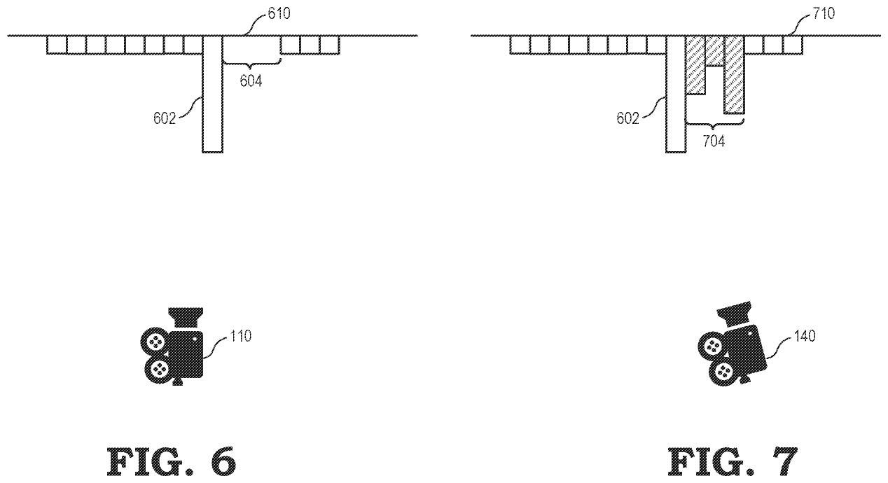

In some cases, the parallax pixel map 120 does not include information for every pixel that is visible from the perspective of the current camera view 140. For example, an object that is close to the first camera view 110 may obstruct the view of objects that are behind the object. As the camera view shifts, the objects that were obstructed from the first camera view 110 may come into view. FIG. 6 is a diagram illustrating an example of a height map 610 with blank pixels 604 based on a last known camera view (first camera view 110) in accordance with some embodiments. In the illustrated example, a group of pixels 604 are blocked from the view of the first camera view 110 by a pixel 602. The GPU 136 identifies the blank pixels 604 that have no corresponding pixels of the updated parallax pixel map and assigns values to the blank pixels.

In some embodiments, the GPU 136 assigns values to the blank pixels based on the values of pixels adjacent to the blank pixels. FIG. 7 illustrates an example of the client device 130 of FIG. 1 assigning values 704 to the blank pixels 604 of FIG. 6 based on the current camera view 140 in accordance with some embodiments to generate an updated height map 710. For example, in some embodiments, the GPU 136 assigns a value to a blank pixel that is an average of the values of the nearest neighboring pixels. In other embodiments, the GPU 136 treats each parallax pixel map pixel as a voxel, such that when the parallax pixel map is projected, each pixel is projected as a line based on height from which the voxel can fill in multiple pixels of the image 122 stored at the frame buffer 132. Because the voxels can overlap, in some embodiments, the GPU 136 selects which direction to render the display frame 150 (e.g., left to right, top to bottom, right to left, bottom to top) based on the angle between the first camera view and the current camera view. In some embodiments, the GPU 136 divides the display frame 150 into a plurality of sections and selects a direction to render each section of the display frame 150.

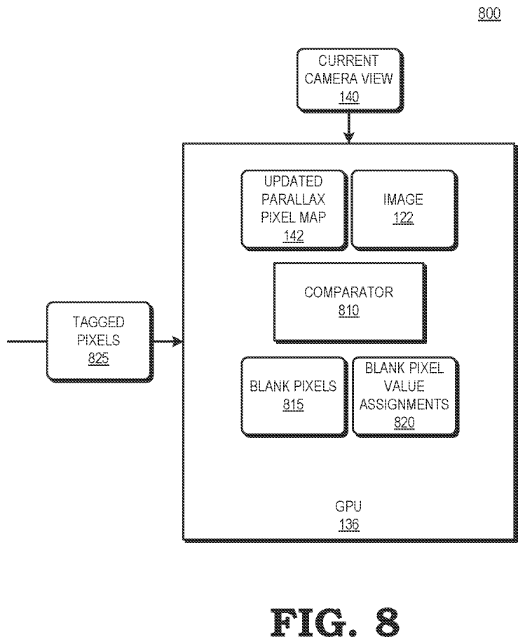

FIG. 8 is a block diagram illustrating an example 800 of the client device 130 of FIG. 1 assigning values to blank pixels based on the current camera view in accordance with some embodiments. The GPU 136 includes a comparator 810 configured to compare the updated parallax pixel map 142 to the image 122. The comparator 810 determines if any pixels of the image 122 do not have corresponding pixels in the updated parallax pixel map 142. The comparator 810 identifies the blank pixels 815 and assigns values to the blank pixels 815 (referred to as blank pixel value assignments 820) as discussed above, either by blending the blank pixels 815 with their adjacent pixels, or by treating each parallax pixel map pixel as a voxel that is projected as a line based on height.

In some instances, the projections of the updated parallax pixel map 142 onto the image 122 can result in multiple pixels of the image 122 being drawn from the same pixel of the updated parallax pixel map 142. This can occur, for example, from large camera rotation movements or from rendering both virtual reality viewports (one for each eye) with a single updated parallax pixel map 142. To reduce the loss of detail from multiple image 122 pixels being drawn from the same updated parallax pixel map 142 pixel, in some embodiments, the server 102 sends information for additional “tagged” pixels 825 that are not visible from the first camera view 110 due to its orientation. The GPU 136 determines where to render the tagged pixels 825 by performing voxel projections for a plurality of likely current camera views 140. The GPU 136 identifies areas of repeated updated parallax pixel map pixels and renders the tagged pixels 825 in the identified areas from the different current camera views 140.

In some embodiments for streamed VR applications, the server 102 combines two video streams (one for each eye) into a single parallax pixel map. For example, in some embodiments, the server 102 renders a scene with an average of the perspectives for each eye and then adds information for additional tagged pixels 825 for each of the perspectives. In this way, the server 102 improves performance, reduces the required bandwidth for streaming the parallax pixel map, and minimizes system requirements such as data cache and DRAM for the client.

To handle flat reflections such as a mirror (not shown), in some embodiments the server 102 provides a second parallax pixel map (not shown). The GPU 136 projects the second parallax pixel map onto the mirror using the current camera view 140 as described above. In some embodiments, the GPU 136 uses a textured plane or spherical subsurface to cast the reflection. For reflections from non-flat surfaces, the GPU 136 casts a ray from each pixel on the surface to find the color of the pixel.

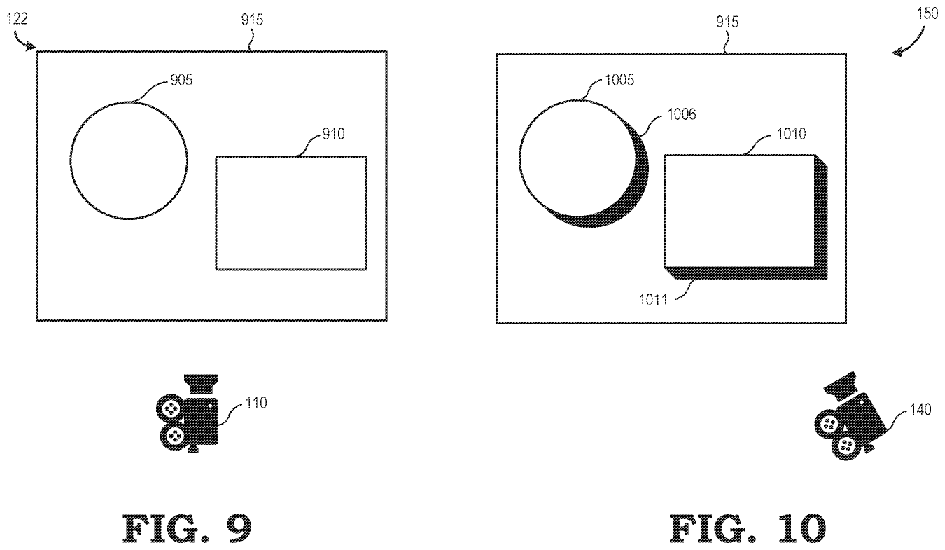

FIG. 9 is a diagram illustrating an example of an image 122 of a scene based on a last known camera view 110 received at the client device of FIG. 1 in accordance with some embodiments. In the illustrated example, the image 122 includes detailed geometry and shading information for two objects 905 and 910. The image 122 further includes a flat background image such as a skybox 915 that appears at a sufficiently large distance from the first camera view 110 that it will also appear to be at a large distance from any updated camera view 140. The server sends the image 122 and a height map based on the first camera view 110 to the client device 130.

FIG. 10 is a diagram illustrating an example of the client device 130 of FIG. 1 rendering the image 122 of FIG. 9 based on the current camera view 140 in accordance with some embodiments. The client device 130 receives the parallax pixel map 120 including the image 122 and the height map 124. The client device 130 updates the parallax pixel map 120 based on the current camera view 140 by casting rays 206 to identify a portion 210 of the parallax pixel map 120 that is visible from the current camera view 140 and by updating the height map 124 based on the current camera view 140. In some embodiments, the GPU 136 identifies blank pixels 815 and generates blank pixel value assignments 820 to fill in pixels that do not have a projected parallax pixel map pixel. The projection module 510 projects the updated parallax pixel map 142 onto the image 122 at the frame buffer 132 to generate the display frame 150.

The display frame 150 includes the skybox 915, which in some embodiments is the same as the skybox 915 in the image 122, because the skybox 915 is at a sufficient distance from both the first camera view 110 and the current camera view 140 that the skybox 915 appears unchanged. In the illustrated example, the objects 905, 910 of the image 122 are rendered as objects 1005, 1010 in the display frame 150. Due to the change in camera orientation and placement from the first camera view 110 to the current camera view 140, additional features 1006, 1011 of objects 1005, 1010 are visible from the current camera view 140. The GPU 136 renders the additional features 1006, 1011 based on the updated parallax pixel map 142.

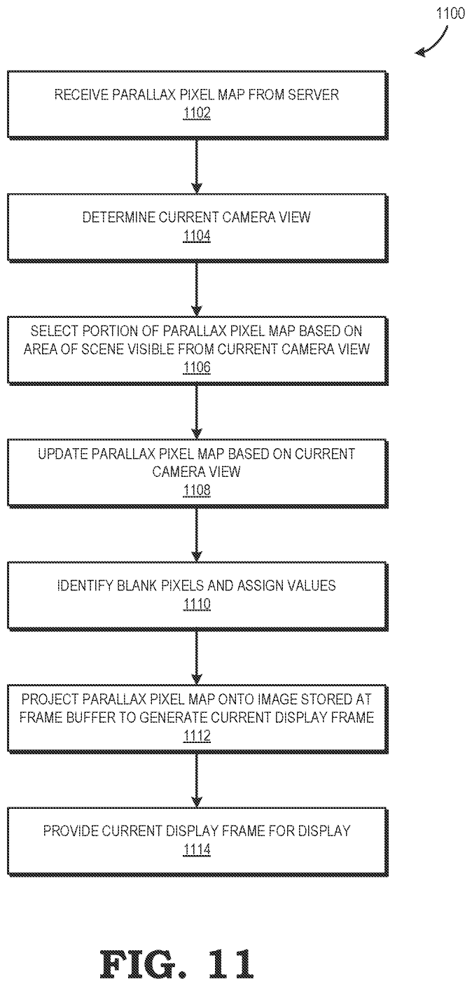

FIG. 11 is a flow diagram of a method 1100 of updating rendered content at a client device 130 based on a current camera view 140 for display in accordance with some embodiments. At block 1102, the client device 130 receives a parallax pixel map 120 including an image 122 and a height map 124 from the server 102. At block 1104, the client device 130 including an image 122 and a height map 124. At block 1104, the client device 130 determines a current camera view 140 based on a user input. At block 1106, the GPU 136 selects a portion 210 of the parallax pixel map 120 based on an area of the scene in the parallax pixel map 120 that is visible from the current camera view 140. In some embodiments, the GPU 136 casts rays 206 from the four corners of the current camera view 140 to identify the visible portion 210 of the parallax pixel map 120. At block 1108, the GPU 136 updates the parallax pixel map 120 based on the current camera view 140 by updating the height map 124 to reflect the updated distance of each pixel of the parallax pixel map 120 from the current camera view 140.

At block 1110, the comparator 810 identifies blank pixels 815 that do not have corresponding pixels in the updated parallax pixel map 142 and the GPU 136 assigns values 820 to the blank pixels 815. In some embodiments, the GPU 136 assigns the values 820 to the blank pixels 815 by blending the blank pixels 815 with their adjacent pixels. In some embodiments, the GPU 136 assigns the values 820 to the blank pixels 815 by treating each parallax pixel map pixel as a voxel that is projected as a line based on height. In addition, in some embodiments the GPU 136 receives information for tagged pixels 825 from the server 102 to use for pixels that are not visible from the first camera view 110 due to its orientation.

At block 1112, the projection module 510 projects the updated parallax pixel map 142 onto the image 122 stored at the frame buffer 132 to generate the current display frame 150. The current display frame 150 includes the computationally-intensive detailed geometry and shading for objects in the scene received from the server 102 and an updated perspective based on the current camera view 140, thus enabling the relatively client device 130, with its relatively small compute power, to render detailed, high-quality images from the current camera view 140 at lower latency than would be possible if the current display frame 150 were rendered at the server 102. At block 1114, the client device 130 provides the current display frame 150 for display.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

1. A method comprising:
receiving, at a client device, a parallax pixel map comprising a first image of a scene and a height map, wherein the first image comprises a plurality of pixels from a perspective of a first camera view, and wherein the height map indicates a distance of each pixel of the first image from the first camera view;
updating the parallax pixel map based on a first current camera view of the scene from a current perspective of the client device to generate an updated parallax pixel map comprising at least one of an updated first image and an updated height map;
rendering a current display frame based on the updated parallax pixel map; and
providing the current display frame for display.

2. The method of claim 1, wherein generating the current display frame comprises projecting the plurality of pixels of the updated parallax pixel map onto corresponding pixels of the first image at a frame buffer.

3. The method of claim 2, further comprising:
identifying a portion of the parallax pixel map based on a portion of the scene that is visible from the first current camera view at the client device; and
wherein projecting the parallax pixel map comprises projecting the portion of the parallax pixel map onto the first image to generate the current display frame.

4. The method of claim 1, wherein updating the parallax pixel map comprises updating the height map based on a distance of each pixel of the first image from the first current camera view at the client device.

5. The method of claim 1, wherein updating the parallax pixel map is based on a change in rotation or position from the first camera view to the first current camera view.

6. The method of claim 1, further comprising:
identifying blank pixels of the first image that have no corresponding pixels of the updated parallax pixel map; and
assigning values to the blank pixels.

7. The method of claim 6, wherein the values assigned to the blank pixels are based on one of:
values of pixels adjacent to the blank pixels; or
voxels based on an angle between the first camera view and the first current camera view.

8. The method of claim 1, wherein the parallax pixel map comprises information for rendering pixels that are not visible from the perspective of the first camera view.

9. The method of claim 1, further comprising:
updating the parallax pixel map based on a second current camera view at the client device;
generating a second current display frame based on the updated parallax pixel map; and
providing the second current display frame for display at the client device.

10. A method, comprising:
receiving, at a client device, a parallax pixel map comprising an image of a scene from a first camera view comprising a plurality of pixels and a height map indicating a distance of each pixel of the image from the first camera view;
identifying a portion of the image of the parallax pixel map that is visible from a current camera view;
projecting the plurality of pixels of the portion of the parallax pixel map onto corresponding pixels of the image at a frame buffer to render a current display frame from the current camera view; and
providing the current display frame for display.

11. The method of claim 10, further comprising updating the parallax pixel map based on the current camera view at the client device to generate an updated parallax pixel map.

12. The method of claim 10, wherein updating the parallax pixel map comprises updating the height map based on a distance of each pixel of the image of the scene from the current camera view.

13. The method of claim 11, wherein updating the parallax pixel map is based on a change in rotation or position from the first camera view to the current camera view.

14. The method of claim 11, further comprising:
identifying blank pixels of the image that have no corresponding pixels of the updated parallax pixel map; and
assigning values to the blank pixels.

15. The method of claim 14, wherein the values assigned to the blank pixels are based on one of:
values of pixels adjacent to the blank pixels; or
voxels based on an angle between the first camera view and the current camera view.

16. The method of claim 1, wherein the parallax pixel map is received from a server having rendered the first image based on the first camera view.

17. The method of claim 1, wherein the parallax pixel map is part of rendered game content streamed to the client device.

18. A client device, comprising:
a central processing unit to receive a parallax pixel map comprising an image of a scene comprising a plurality of pixels from a first camera view and a height map indicating a distance of each pixel of the image from the first camera view; and
a graphics processing unit (GPU) to:
update the parallax pixel map based on a current camera view from a current perspective of the client device to generate an updated parallax pixel map;
project the updated parallax pixel map onto corresponding pixels of the image to generate a current display frame; and
provide the current display frame for display.

19. The client device of claim 18, wherein the GPU is to:
update the parallax pixel map by updating the height map based on a distance of each pixel of the image of the scene from the current camera view.

20. The client device of claim 18, wherein the GPU is to:
update the parallax pixel map based on a change in rotation or position from the first camera view to the current camera view.

21. The client device of claim 18, wherein the GPU is to:
identify blank pixels of the image that have no corresponding pixels of the updated parallax pixel map; and
assign values to the blank pixels.

22. The client device of claim 21, wherein the GPU is to assign values to the blank pixels based on one of:
values of pixels adjacent to the blank pixels; or
voxels based on an angle between the first camera view and the current camera view.

23. (canceled)
